(19) United States
(12) Patent Application Publication
(10) Pub. No.: US 2002/0028070 A1
(43) Pub. Date: Mar. 7, 2002

(54) HEATING SYSTEM FOR CRUDE OIL TRANSPORTING METALLIC TUBES

(76) Inventor: PETTER HOLEN, KLOFTA (NO)

Correspondence Address: SUGHRUE MION ZINN MACPEAK & SEAS PLLC, 2100 PENNSYLVANIA AVENUE NW, SUITE 800, WASHINGTON, DC, 200373213

(21) Appl. No.: 09/393,459

(22) Filed: Sep. 10, 1999

(30) Foreign Application Priority Data
Sep. 14, 1998 (NO) 98 4 235

(51) Int. Cl. H05B 3/40

(52) U.S. Cl. 392/478

(57) ABSTRACT

Heating system for crude oil or other viscous fluids transporting metallic tubes having a thermal insulation, wherein a defined length of the said metallic tube acts as a heating element, which is electrically insulated by the tube insulation itself and whereby the metallic tube has connections with respective feeder and return cables at the beginning and at the end of the length of the tube defining the length of the heating element.

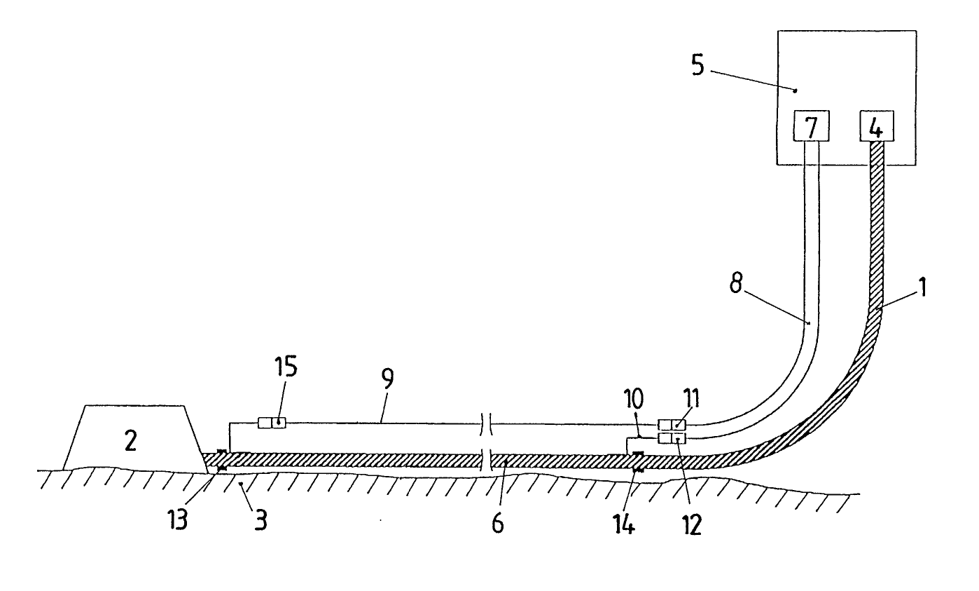

The present invention relates to a heating system for crude oil or other viscous fluids transporting metallic tubes having a thermal insulation.

Such metallic tubes, also called pipelines, are used e.g. for crude oil transporting from the sea bottom, where the oil will be pulled out of the ground up to the platform or up to a ship to be loaded with the produced crude oil. Often it is also necessary to reload another one whereby a pipeline for oil transportation is connecting both ships.

If the crude oil upstream flow has to be stopped because of repair purposes or for making a cross check of the plant or to stop the un- and reloading of ships remaining oil inside the pipeline may obtain a viscosity forming plugs, which will not allow to start the drawing of loading procedure again. The remaining oil therefore has to be removed from the inside of the pipeline, often a very expensive procedure. Over that such a pipeline cleaning is time consuming.

To avoid such disadvantages it is, therefore, an object of the invention to provide means which will allow starting and dropping crude oil transportation without any problem. Another object of the invention is to keep the viscosity of the remaining oil inside the pipeline or tube sufficiently low at least during the phase of stopping oil transportation.

A third object of the present invention is to have a low cost solution to avoid the above problems, also without changing the design of the pipeline/metallic tube used normally for crude oil or other viscous fluids transportation.

According to this invention there is provided a heating system where a defined length of the metallic tube (pipeline) acts as a heating element, which is electrically insulated by the tube insulation itself and whereby the metallic tube has connections with respective feeder and return cables at the beginning and at the end of the length of the tube defining the length of the heating element.

From the GB 2 084 284 A a heated pipeline is well-known describing a special design with two concentric metal tubes whereby both tubes and over the whole length will act as a feeder and a return conductor of an electric power source. This known method is cost consuming because it is necessary to have the whole length of the pipeline being heated and of the special design of the pipeline itself used corresponding to the above document for long-distance transportation of crude oil having in mind a substantially constant viscosity of the crude oil itself.

Preferably according to the invention the thermal insulation which warrants the crude oil being on a sufficiently low level of viscosity during transportation and acts simultaneously as the electrical insulation in the section where the metal tube acts as a heating element, is made of an extruded polymeric material, this may also be crosslinked. Due to its good thermal and electrical quality polypropylene will be especially used.

In the case the metallic tube is hanging in the sea water, e.g. between two ships or between a ship and a platform, or is laid on the sea bed according to the invention the feeder and the return cables are connected with the corresponding conductors of an electrical single phase armoured riser AC high current cable. This cable may contain additional conductors for feeding a second or third heating system for pipelines. For the same purposes it is also possible to have the feeder and the return cables as a part of an electrical single phase armoured riser AC high current cable. A part means that having cut back or removed the outer sheath the armouring etc. from the riser cable the insulated feeder and the return conductor of the said cable alone will extend up to the connection points given by the defined length or section of the metallic tube or tubes if two or more heating systems for pipelines have to be powered.

According to the invention the service voltage of the riser cable normally is between 5 and 40 KV, whereby the service current to heat the metallic tube at defined sections is up to 2.000 A, especially between 600 and 1.600 A.

For acting partially as a heating element the metallic tube is preferably made of a ferromagnetic material. The outer surface of the metallic tube will be smooth but with respect to increase its flexibility and transverse strength it could be useful to have it corrugated.

For handling the pipeline and the feeder/return conductors as a whole it is a further principle of the present invention to have the feeder and/or the return cable being attached to the insulated metallic tube (pipeline). This could be done by fastening the feeder and/or the return cable on its outer surface by clamping elements or by fixing them on the pipeline surface by a common wrapping of tapes or cords. Another possibility would be to strand the feeder and/or the return cable around the pipeline to have both fixed on the outer surface of the insulated metallic tube.

To enable the invention to be clearly understood its principle will now be described by way of example with reference to the accompanying drawing.

In the FIGURE there is illustrated an insulated metallic tube 1 (pipeline) connecting the template 2 installed at the sea bottom 3 with the process unit 4 installed on the platform 5. Because of the thermal insulation of the metallic tube 1 the crude oil coming from the template 2 can be transported with a sufficient viscosity to the platform 5. If for any reason the crude oil transportation has to be stopped the formation of hydrate plugs or wax deposits may occur. When starting transportation again the plugs and remaining cold crude oil in the section 6 will block new oil transportation because of its higher viscosity inspite of the thermal insulation of the metallic tube 1.

To avoid such a problem the metal tube 1 in the section 6 will be heated by direct impedence heating. For this purpose a single phase power supply 7 installed on the platform 5 is connected with a riser cable 8 containing one or more insulated feeder and return conductors, maybe stranded with another and being protected in the normal way by an armouring and an outer sheathing. The feeder and return cables may have connectors.

At the end of the riser cable 8 its armouring and sheathing has been cut back and one feeder and one return conductor is connected with a corresponding feeder cable 9 and a respective return cable 10 by connecting elements 11 and 12. Insulated flanges 13 and 14 act as connecting devices for the feeder cable 9 and the return cable 10 with the metallic tube (pipeline) 1. Although the design of the flanges 13 and 14 may be quite different it is necessary to have a dimension for current transport to the metallic tube 1 up to 12.000 A and the flanges must be insulated towards the sea water. The flow line section between the processing unit 4 and the electric insulating flange 14 may be of a flexible flowline design.

Instead of using conncetors in having the riser cable 8 being connected with the feeder cable 9 and the return cable 10 both consisting only of a power core with an insulation but without an outer metallic screen and/or armouring sometimes it will be useful to cut back or remove the armouring and the sheath of the riser cable as before but to extend the feeder and the return conductor of the riser cable now as feeder cable 9 and return cable 10 to the connecting flanges 13 respectively 14. The electrical flanges 13 and 14 electrically isolate the section 6 from the rest of the pipeline; i.e. there is no metallic (electric) path through these items.

In the case of a stop of crude oil transportation in the metal tube 1 before and/or during and/or after oil stop section 6 of the metal tube 1 will be heated by direct impedance from the single phase power supply 7 with the service voltage. The section 6 heated by an AC current flow secures that at the time of oil transportation starting the remained crude oil will have sufficiently low viscosity.

The present invention should not be restricted to the above example showing the principle. So the same heating system can be used in the case crude oil transportation has to be made between a template on the sea bottom and a ship or between two or more ships.

The FIGURE shows the feeder cable 9 and the return cable 10 laid in parallel relationship to the section 6 of the metallic tube 1. For handling and protection purposes the normal arrangement would be that at least the feeder cable 9 and the return cable 10 are attached to the insulated metal tube 1, in section 6 during installation.

A connector 15 will ease feeding cable repair after any damage.

1. Heating system for crude oil or other viscous fluids transporting metallic tubes having a thermal insulation, characterized in that a defined length of the said metallic tube acts as a heating element, which is electrically insulated by the tube insulation itself and whereby the metallic tube has connections with respective feeder and return cables at the beginning and at the end of the length of the tube defining the length of the heating element.

2. System according to claim 1, characterized in that the heating element is electrically insulated by insulated flanges.

3. System according to claim 1 or 2, characterized in that the tube insulation is made of an extruded, optionally crosslinked polymeric material.

4. System according to claim 3, characterized in that the polymeric material is a polypropylene.

5. System according to any of the claims 1 to 4 where the metallic tube is laid on the sea bed or hanging in the sea, characterized in that the feeder and return cables are connected with an electrical single phase armoured riser AC high current cable.

6. System according to any of the claims 1 to 5 where the metallic tube is laid on the sea bed or hanging in the sea, characterized in that the feeder and return cables are part of an electrical single phase armoured riser AC high current cable.

7. System according to claim 5 or 6, characterized in that the service voltage of this riser cable is between 5 and 40 KV.

8. System according to claim 5 or 6, characterized in that the service current of the riser cable is up to 2.000 A, especially between 600 and 1.600 A.

9. System according to any of the claims 1 to 8, characterized in that the feeder and the return cable are single insulated power conductors.

10. System according to any of the claims 1 to 8, characterized in that the pipeline has electrical insulating flanges for connecting the feeder and the return cable with the metallic tube which define its section acting as a heating element.

11. System according to any of the claims 1 to 10, characterized in that the metallic tube is made of ferromagnetic material.

12. System according to any of the claims 1 to 11, characterized in that the metallic tube is a plain tube.

13. System according to any of the claims 1 to 12, characterized in that the metallic tube is corrugated.

14. System according to any of the claims 1 to 13, characterized in that the feeder and/or the return cable is attached to the insulated metallic tube.

15. System according to claim 14, characterized in using fastening means for having the feeder and/or the return cable attached to the insulated metallic tube.

16. System according to claim 14, characterized in that the feeder and/or the return cable is stranded around the insulated metallic tube.
